(19) United States
(12) Patent Application Publication
(10) Pub. No.: US 2025/0227077 A1
(43) Pub. Date: Jul. 10, 2025

(54) Router-Bridge Capable of Fast Exchanging Network Packets

(71) Applicant: MEDIATEK INC., Hsin-Chu (TW)

(72) Inventor: Chun-Te Wu, Hsinchu City (TW)

(73) Assignee: MEDIATEK INC., Hsin-Chu (TW)

(21) Appl. No.: 18/408,589

(22) Filed: Jan. 10, 2024

(51) Int. Cl. H04L 49/90; H04L 49/102; H04L 49/60

(52) U.S. Cl. CPC H04L 49/9094; H04L 49/102; H04L 49/602

(57) ABSTRACT

A router-bridge system includes a plurality of frame engines, at least one offload engine, and a bus. Each frame engine includes an ingress gateway and an egress gateway. The ingress gateway is used to receive a plurality of ingress packets and convert protocols of the plurality of ingress packets to generate a plurality of L2 packets. The egress gateway is used to output a plurality of egress packets. The at least one offload engine is in communicate with at least two of the plurality of frame engines and used to modify the plurality of ingress packet or the plurality of egress packet. The at least one offload engine is shared by the at least two of the plurality of frame engines. The bus is used to facilitate communication between the plurality of frame engines.

### BACKGROUND

The Open Systems Interconnection (OSI) model is a conceptual model that describes the communication functions of data communication or computing system without regard to their underlying internal structure and technology. The OSI model partitions the flow of data in a communication system into seven layers (layer 1 to layer 7, or L1 to L7) to describe networked communication from the physical implementation of transmitting bits across a communications medium to the highest-level representation of data of a distributed application.

Legacy network devices are classified into L2 bridges, and L3 or L4 routers based on the OSI model and the Institute of Electrical and Electronics Engineers (IEEE) standards. Bridges operate at the data link layer (layer 2) of OSI model and are used to connect two or more local area networks (LANs) together by forwarding data packets between them based on their Media Access Control (MAC) address. Routers, on the other hand, operate at the network layer (layer 3 or 4) of the OSI model and are used to connect two or more networks together including LANs and wide area networks (WANs). Both devices can improve network performance and security, but they have different functions and capabilities. The main difference between bridges and routers is that bridges only forward data packets within a single LAN while routers can forward packets between different LANs or WANS.

In a LAN to WAN network flow, packets are first sent to an L2 bridge and then redirected to an L3 or L4 router. Once the routing engine processes the packets, they are sent back to the L2 bridge for delivery to the device of their final destination. If the L2 bridge has multiple receiving ports, more network trunks or high-speed interfaces would be necessary to forward packets to the L3 or L4 router. Similarly, the packets processed by the router would then be forwarded back to the L2 bridge through the same trunks or interfaces.

There are several drawbacks with the legacy devices. Firstly, there is not enough bandwidth on the external interface between the bridge and router. As the number of ports and their speed increase, ultra-high-speed interfaces would be required on both ends.

Secondly, the port number on the L2 bridge may vary with different products. Designers would have to redesign the internal buffer size whenever the port number changes in order to accommodate packet storage. Additionally, the L3 router must take into account the packet-per-second (pps) requirement or modify the packet information to cover all L2 ports. This limits the ability to scale network devices.

Thirdly, packets transmitted via an IEEE 802.11 interface may need advanced tunneling or VPN capabilities. As the router is equipped to handle both IEEE 802.3 and IEEE 802.11 packet flow, the central packet processor must have more processing engines which in turn can result in longer packet latency. These additional processing engines and latency are unnecessary for LAN-to-LAN packet flows.

### SUMMARY

An embodiment provides a router-bridge system including a plurality of frame engines, at least one offload engine, and a bus. Each frame engine includes an ingress gateway and an egress gateway. The ingress gateway is used to receive a plurality of ingress packets and convert protocols of the plurality of ingress packets to generate a plurality of L2 packets. The at least one offload engine is in communicate with at least two of the plurality of frame engines and used to modify the plurality of ingress packet or the plurality of egress packet. The at least one offload engine is shared by the at least two of the plurality of frame engines. The bus is used to facilitate communication between the plurality of frame engines. The egress gateway converts protocols of the plurality of modified packets to generate a plurality of egress packets and output a plurality of egress packets.

An embodiment provides a method of processing network packets with a router-bridge system. The router-bridge system includes a plurality of frame engines, at least one offload engine shared by at least two of the plurality of frame engines, and a bus. Each frame engine includes an ingress gateway and an egress gateway. The method includes receiving a plurality of ingress packets by the ingress gateway, converting the plurality of ingress packets by the ingress gateway to generate a plurality of L2 packets, modifying the plurality of L2 packets according to network protocols to generate a plurality of processed packets, modifying the plurality of processed packets according to the network protocols to generate a plurality of modified packets, converting the plurality of modified packets to a plurality of egress packets by the egress gateway, and outputting the plurality of egress packets by the egress gateway.

Another embodiment provides a router-bridge system including a plurality of frame engines and an offload engine in communication with each frame engine. Each frame engine is used to receive a plurality of L2 packets. The offload engine is used to modify the plurality of L2 packets according to network protocols to generate a plurality of modified packets. The offload engine is shared by at least two of the plurality of frame engines. The bus is used to facilitate communication among the plurality of frame engines and the memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of a router-bridge system of an embodiment.

FIG. 2 illustrates a diagram of a router-bridge system of another embodiment.

FIG. 3 illustrates a diagram of a router-bridge system of another embodiment.

FIG. 4 illustrates a flowchart of a method for processing network packets with the router-bridge systems of the embodiments.

### DETAILED DESCRIPTION

For purposes of furthering understanding of the disclosure, some explanation will be provided for numerous networking computing devices and protocols.

The Open Systems Interconnection (OSI) model is a conceptual model that describes the communication functions of a telecommunication or computing system without regard to their underlying internal structure and technology. The OSI model partitions the flow of data in a communication system into seven layers (layer 1 to layer 7, or L1 to L7) to describe networked communication from the physical implementation of transmitting bits across a communications medium to the highest-layer representation of data of a distributed application.

A bridge (may alternatively be referred to as a switching hub, switch, or MAC bridge, and usually operates in layer 2) inspects the incoming traffic from each network device, such as computers, phones, printers, and routers, and determines whether to forward or discard it based on the destination MAC address. A bridge can also segment a large network into smaller ones, reducing the number of collision domains and improving the network performance. It can also maintain a forwarding table that maps each MAC address to the corresponding network segment. A bridge serves as a controller that enables networked devices to talk to each other efficiently.

A router (usually operates in layer 3 and/or layer 4) performs the function of routing, which is the process of selecting a path for the data packets to travel from their source to their destination. When a router receives a packet, it reads the header of the packet to see its intended destination IP address. It then consults its routing table, which records the paths to various network destinations, and determines where to send the packet next. The packet may pass through several routers before reaching its final destination.

An offload engine is a hardware or software component that takes over some of the processing tasks from another component, such as a central processing unit (CPU) or a network interface card (NIC). This can free up the other component to focus on other tasks, which can improve overall performance. One common type of offload engine is a Transmission Control Protocol (TCP) offload engine (TOE). A TOE can take over all of the processing tasks associated with the TCP protocol, including checksum calculation, sequence number management, and retransmission. This can significantly reduce the CPU overhead of TCP processing, especially on high-speed networks. Another common type of offload engine is a large receive offload (LRO) engine. An LRO engine can aggregate multiple incoming packets from a single stream into a larger buffer before they are passed up the networking stack. This can reduce the number of interrupts that the CPU has to handle, which can improve performance and reduce latency. Offload engines are used in a variety of applications, including networking, storage, and security. For example, TOEs are often used in network routers and switches to improve performance and reduce CPU overhead.

Another type of offload engine is Hardware Network Address Translation (NHAT), which allows multiple devices on a local network to share a single public IP address. NHAT is implemented by a router or a firewall that performs the translation of private IP addresses to public IP addresses and vice versa. NHAT enables devices on a local network to communicate with the Internet without exposing their internal network topology or consuming too many public IP addresses. NHAT also provides some security benefits, such as hiding the identity and location of the devices behind the router or firewall, and preventing direct attacks from external sources.

A network frame engine (hereinafter referred to as “frame engine”) is a dedicated interface responsible for processing L2 packets (i.e., frames). The L2 packets contain information about the sender and receiver of the data, as well as the type of data that is being transmitted. The frame engine can receive packets via ingress ports, parse the L2 packets, extract the necessary information, and then forward the L2 packets to the appropriate destination via the egress ports. Frame engines may be used in a variety of networking devices, including routers, switches, and firewalls.

IEEE 802.3 protocols, specified by the IEEE, are a collection of standards that define the physical layer (PHY) and media access control (MAC) layer of the data link layer of wired Ethernet networks. IEEE 802.3 is the most widely used Ethernet standard in the world and is used in a variety of applications, including local area networks (LANs), metropolitan area networks (MANs), and wide area networks (WANs).

IEEE 802.11 protocols, also specified by the IEEE, are a set of standards that define the MAC and PHY layers for wireless local area networks (WLANs). IEEE 802.11 protocols operate in a variety of frequency bands, including 2.4 GHz, 5 GHz, and 6 GHz.

Gigabit Passive Optical Network (GPON) is a type of fiber-optic network that uses a single fiber to deliver high-speed internet, voice, and video services to multiple subscribers. GPON is a point-to-multipoint network, which means that a single optical line terminal (OLT) at the service provider's central office can serve multiple optical network units (ONUs) at the subscriber's premises.

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure. It should be understood that the disclosure is described primarily in the context of 3GPP specified network (e.g., 4G and 5G), IEEE 802.11 specified network (e.g., Wi-Fi), IEEE 802.3 specified network, and Gigabit Passive Optical Network (GPON), but it can be implemented in other forms of networks as well.

For terms and techniques not specifically described, reference may be made to communication standard documents (e.g., IEEE Standard for Information Technology) issued before this specification.

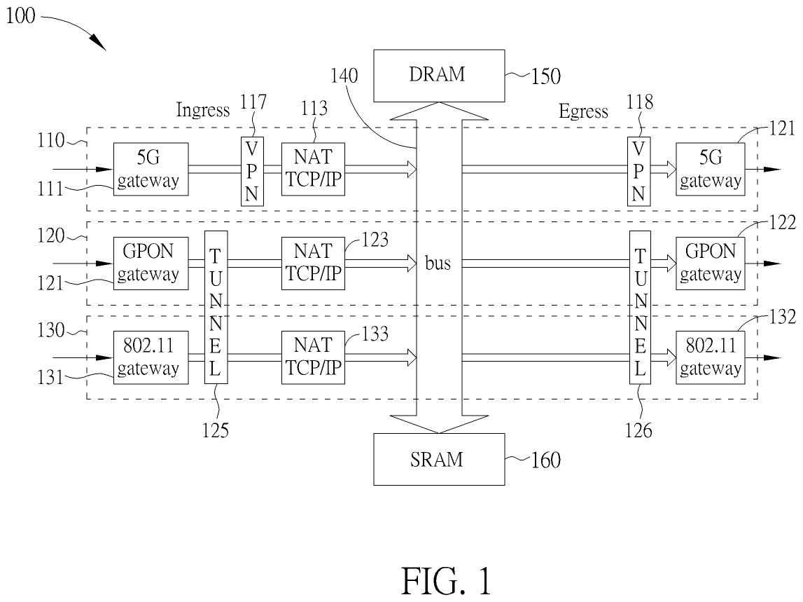

FIG. 1 illustrates a diagram of a router-bridge system 100 of an embodiment. The router-bridge system 100 includes frame engines 110, 120 and 130, a bus 140, dynamic random-access memory (DRAM) 150, and static random-access memory (SRAM) 160. The bus 140 is used to facilitate communication among the frame engines 110, 120 and 130, and used to access the DRAM 150 and the SRAM 160.

The router bridge system 100 may also include at least one offload engine shared by the frame engines. In this case, the at least one offload engine may include an ingress tunneling offload engine 125 and an egress tunneling offload engine 126 in communication with and shared by the frame engines 120 and 130. The bus 140 may be, for example, an Advanced extensible Interface (AXI) bus or the equivalent thereof.

The frame engine 110 may include a 5G ingress gateway 111, a 5G egress gateway 112 and a network address translation (NAT) and TCP/IP offload engine 113. The frame engine 110 may additionally include an ingress VPN (Virtual Private Network) offload engine 117 and an egress VPN offload engine 118. On the ingress side, the 5G ingress gateway 111 can receive 5G ingress packets (e.g., L3 or L4 packets) and convert protocols of the 5G ingress packets to IEEE 802.3 protocols to generate L2 packets. The L2 packets can then be processed by the NAT and TCP/IP offload engine 113. That is, the NAT and TCP/IP offload engine 113 can process some tasks associated with the TCP/IP protocol and NAT such as checksum calculation, sequence number management and segmentation offload. The ingress VPN offload engine 117 can perform VPN associated task on the L2 packets, such as encryption and decryption, compression and decompression, and IPsec processing.

The processed L2 packets can then be store in the memory (e.g., DRAM 150 and/or SRAM 160) for buffering. This allows the router-bridge system 100 to process packets at its own pace, even if the network is congested.

On the egress side, the processed L2 packets can be retrieved from the memory (e.g., DRAM 150 and/or SRAM 160) and sent to the egress VPN offload engine 118 for VPN associated tasks (as described above). Then, the 5G egress gateway 112 can convert protocols of processed L2 packets (e.g., IEEE 802.3 protocols) to 5G protocols to generate egress packets (e.g., L3 or L4 packets) and forward them to their destinations.

The frame engine 120 may include a Gigabit Passive Optical Network (GPON) ingress gateway 121, a GPON egress gateway 122 and a NAT and TCP/IP offload engine 123. On the ingress side, the GPON ingress gateway 111 can receive GPON ingress packets (e.g., L3 or L4 packets) and convert protocols of the GPON ingress packets to IEEE 802.3 protocols to generate L2 packets. The L2 packets can then be processed by the ingress tunneling offload engine 125. The ingress tunneling offload engine 125 can perform some tasks associated with tunneling protocol on the L2 packets, such as decapsulation and fragmentation.

Next, the processed L2 packets can be further altered by the NAT and TCP/IP offload engine 123. That is, the NAT and TCP/IP offload engine 123 can process tasks associated with the TCP/IP protocol and NAT such as checksum calculation, sequence number management and segmentation offload.

Then, the L2 packets can be store in the memory (e.g., the DRAM 150 and/or the SRAM 160) for buffering. This allows the router-bridge system 100 to process packets at its own pace, even if the network is congested.

On the egress side, the processed L2 packets can be retrieved from the memory (e.g., the DRAM 150 and/or the SRAM 160) and sent to egress tunneling offload engine 126. The egress tunneling offload engine 126 can perform some tasks associated with tunneling protocol on the L2 packets, such as encapsulation, reassembly and routing. After modification, the modified L2 packet can be sent to the GPON egress gateway 122.

The GPON egress gateway 122 can convert protocols of processed L2 packets (e.g., IEEE 802.3 protocols) to GPON protocols to generate egress packets (e.g., L3 or L4 packets) and forward them to their destinations.

The frame engine 130 may include an IEEE 802.11 ingress gateway 131, an IEEE 802.11 egress gateway 132, and a NAT and TCP/IP offload engine 133. On the ingress side, the IEEE 802.11 ingress gateway 111 can receive IEEE 802.11 ingress packets (e.g., L3 or L4 packets) and convert protocols of the IEEE 802.11 ingress packets to IEEE 802.3 protocols to generate L2 packets. The L2 packets can then be processed by the ingress tunneling offload engine 125. The ingress tunneling offload engine 125 can perform some tasks associated with tunneling protocol on the L2 packets, such as decapsulation and fragmentation.

Next, the processed L2 packets can be further altered by the NAT and TCP/IP offload engine 133. That is, the NAT and TCP/IP offload engine 123 can process tasks associated with the TCP/IP protocol and NAT such as checksum calculation, sequence number management, segmentation offload.

Then, the L2 packets can be store in the memory (e.g., the DRAM 150 and/or the SRAM 160) for buffering. This allows the router-bridge system 100 to process packets at its own pace, even if the network is congested.

On the egress side, the processed L2 packets can be retrieved from the memory (e.g., the DRAM 150 and/or the SRAM 160) and sent to the egress tunneling offload engine 126. The egress tunneling offload engine 126 can perform some tasks associated with tunneling protocol on the L2 packets, such as encapsulation, reassembly and routing. After modification by the egress tunneling offload engine 126, the modified L2 packet can be sent to the IEEE 802.11 egress gateway 132.

The IEEE 802.11 egress gateway 132 can convert protocols of processed L2 packets (e.g., IEEE 802.3 protocols) to IEEE 802.11 protocols to generate egress packets (e.g., L3 or L4 packets) and forward them to their destinations.

Because the ingress tunneling offload engine 125 and the egress tunneling offload engine 126 are shared by the different frame engines (e.g., frame engines 110, 120 and 130), they can process L2 packets of the different frames engines at different time periods. Thus, the processing resources can be allocated to the different frame engines at different times. This eliminates the need for designing a dedicated tunneling offload engine for each frame engine. However, the ingress tunneling offload engine 125 and the egress tunneling offload engine 126 are also scalable. That is, more tunneling offload engines may be added when necessary.

It should be noted that the in-band packet message of the L2 packet may also be modified by the various ingress offload engines (e.g., the tunneling ingress offload engine 125). The modification includes but not limited to L2 MAC Bridge, Internet Group Management Protocol (IGMP) and Multicast Listener Discovery (MLD) snooping, L3 and L4 flow index, and Quality of Service (QoS) policy and shape.

The above illustration is merely an example. The present invention is not limited thereto. The various features that are described also can be implemented in combination in a single implementation. Conversely, various features that are described in the context of a single implementation also can be implemented in multiple implementations separately or in any suitable subcombination.

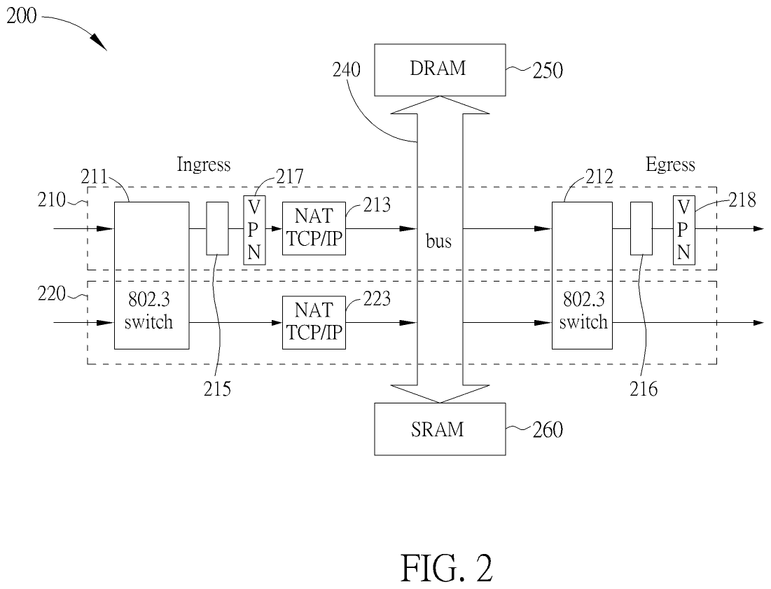

FIG. 2 illustrates a diagram of a router-bridge system 200 of another embodiment. The router-bridge system 200 includes frame engines 210 and 220, an ingress IEEE 802.3 switch 211, an egress IEEE 802.3 switch 212, a bus 240, dynamic random-access memory (DRAM) 250, and static random-access memory (SRAM) 260. The ingress IEEE 802.3 switch 211 and the egress IEEE 802.3 switch 212 may be in communication and shared by the frame engines 210 and 220. The bus 240 is used to facilitate communication between the frame engines 210, 220, and used to access the DRAM 250 and the SRAM 260.

The router bridge system 200 may also include at least one offload engine shared by the frame engines. In this case, the at least one offload engine includes an ingress tunneling offload engine 215 and an egress tunneling offload engine 216 in communication with the frame engines 210. The bus 240 may be, for example, an AXI bus or the equivalent thereof.

In some embodiments, the ingress tunneling offload engine 215 and the egress tunneling offload engine 216 may be in communication with and shared by more than one frame engines according to the implementation.

The frame engine 210 may include a NAT and TCP/IP offload engine 213. Furthermore, the frame engine 210 may additionally include an ingress VPN offload engine 217 and an egress VPN offload engine 218. On the ingress side, the ingress IEEE 802.3 switch 211 can receive L2 packets directly. The L2 packets can then be processed by the ingress tunneling offload engine 215. The ingress tunneling offload engine 215 can perform some tasks associated with tunneling protocol on the L2 packets, such as decapsulation and fragmentation.

Then, the processed L2 packets can be sent to the ingress VPN offload engine 217 for further processing. The ingress VPN offload engine 217 can perform VPN associated task on the L2 packets, such as encryption and decryption, compression and decompression, and IPsec processing.

Then, the L2 packets can be store in the memory (e.g., the DRAM 250 and/or the SRAM 260) for buffering. This allows the router-bridge system 200 to process packets at its own pace, even if the network is congested.

On the egress side, the processed L2 packets can be retrieved from the memory (e.g., the DRAM 150 and/or the SRAM 160) and sent to the egress IEEE 802.3 switch 212 for further modification. Then, the modified L2 packets are sent to the egress tunneling offload engine 216. The egress tunneling offload engine 216 can perform some tasks associated with tunneling protocol on the L2 packets, such as encapsulation, reassembly and routing. After modification by the egress tunneling offload engine 126, the modified L2 packets can be sent to the egress VPN offload engine 218 for VPN associated tasks (as described above). After the egress VPN offload engine 218, the modified L2 packets would be forwarded to their destinations.

The frame engine 220 may include a NAT and TCP/IP offload engine 223. On the ingress side, the ingress IEEE 802.3 switch 211 can receive L2 packets directly. Then, the L2 packets can be store in the memory (e.g., the DRAM 250 and/or the SRAM 260) for buffering. On the egress side, the processed L2 packets can be retrieved from the memory (e.g., the DRAM 150 and/or the SRAM 160) and sent to the egress IEEE 802.3 switch 212 for further modification. Finally, the modified L2 packets would be forwarded to their destinations.

Because the ingress IEEE 802.3 switch 211 and the egress IEEE 802.3 switch 212 are shared by the different frame engines (e.g., frame engines 210 and 220), they can process L2 packets of the different frames engines at different time periods. Thus, the processing resources can be allocated to the different frame engines at different times. This eliminates the need for designing a dedicated IEEE 802.3 switch for each frame engine. However, the ingress IEEE 802.3 switch 211 and the egress IEEE 802.3 switch 212 are also scalable. That is, more IEEE 802.3 switches may be added when necessary.

It should be noted that the in-band packet message of the L2 packet may also be modified by the various ingress offload engines (e.g., the tunneling ingress offload engine 215). The modification includes but not limited to L2 MAC Bridge, Internet Group Management Protocol (IGMP) and Multicast Listener Discovery (MLD) snooping, L3 and L4 flow index, and Quality of Service (Qos) policy and shape.

The above illustration is merely an example. The present invention is not limited thereto. The various features that are described also can be implemented in combination in a single implementation. Conversely, various features that are described in the context of a single implementation also can be implemented in multiple implementations separately or in any suitable subcombination.

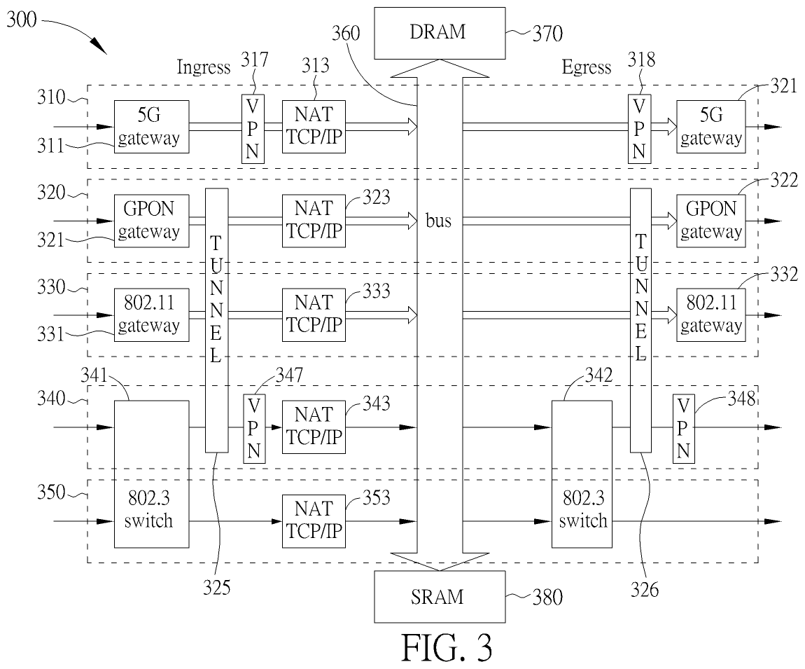

FIG. 3 illustrates a diagram of a router-bridge system 300 of another embodiment. The router-bridge system 300 includes frame engines 310, 320, 330, 340 and 350, a bus 360, dynamic random-access memory (DRAM) 370, and static random-access memory (SRAM) 380. The bus 360 is used to facilitate communication among the frame engines 310, 320, 330, 340 and 350, and used to access the DRAM 370 and the SRAM 380.

The router bridge system 300 may also include at least one offload engine shared by the frame engines. In this case, the at least one offload engine includes an ingress tunneling offload engine 325 and an egress tunneling offload engine 326 in communication with and shared by the frame engines 320, 330 and 340. In addition, an ingress IEEE 802.3 switch 341 and an egress IEEE 802.3 switch 342 are in communication with and shared by the frame engines 340 and 350. The bus 360 may be, for example, an Advanced extensible Interface (AXI) bus or the equivalent thereof.

The frame engines 310, 320, 330, 340 and 350 may respectively include NAT and TCP/IP offload engines 313, 323, 333, 343 and 353.

The frame engine 310 may additionally include an ingress VPN offload engine 317 and an egress VPN offload engine 318. Similarly, the frame engine 340 may additional include an ingress VPN offload engine 347 and an egress VPN offload engine 348. The ingress VPN offload engine 317 and 347 and the egress VPN offload engine 318 and 348 can perform at least some VPN associated task on the L2 packets, such as encryption and decryption, compression and decompression, and IPsec processing.

Because the ingress IEEE 802.3 switch 341 and the egress IEEE 802.3 switch 342 are shared by the different frame engines (e.g., the frame engines 340 and 350), they can process L2 packets of the different frames engines at different time periods. Thus, the processing resources can be allocated to the different frame engines at different times. This eliminates the need for designing a dedicated IEEE 802.3 switch for each frame engine. However, the ingress IEEE 802.3 switch 341 and the egress IEEE 802.3 switch 342 are also scalable. That is, more IEEE 802.3 switches may be added when necessary.

Similarly, because the ingress tunneling offload engine 325 and the egress tunneling offload engine 326 are shared by the different frame engines (e.g., the frame engines 320, 330 and 340), they can process L2 packets of the different frames engines at different time periods. Thus, the processing resources can be allocated to the different frame engines at different times. This eliminates the need for designing a dedicated tunneling offload engine for each frame engine. However, the ingress tunneling offload engine 325 and the egress tunneling offload engine 326 are also scalable. That is, more tunneling offload engines may be added when necessary. In the other example, similarly to the tunnel offload engine 325 and 326, VPN offload engine 317, 347, 318, and 348 can be one offload engine shared by the frame engines 310 and 340.

All other features and operations of the router-bridge system 300 are the same or similar to the router-bridge systems 100 and/or 200. Thus, the description will not be repeated herein for brevity.

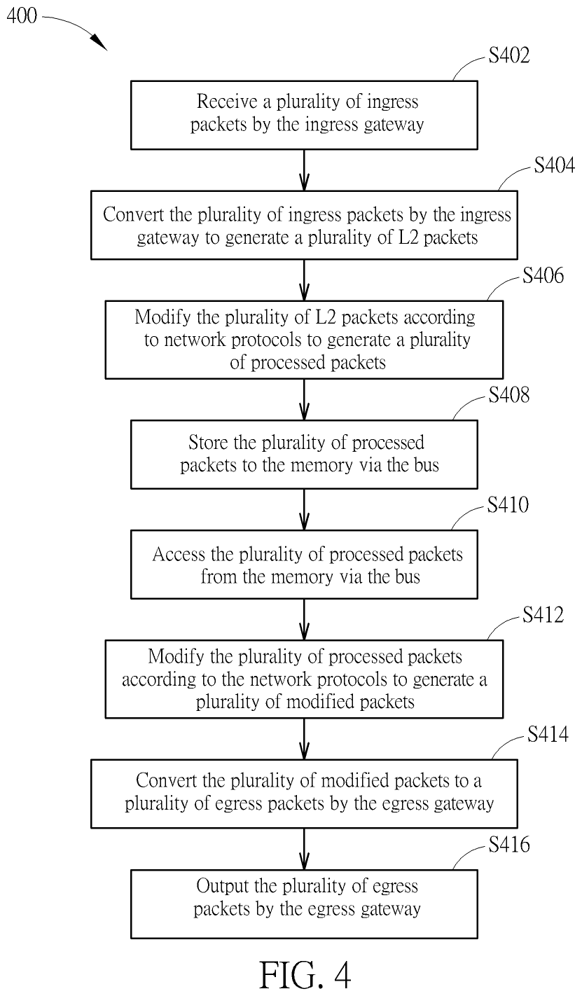

FIG. 4 illustrates a flowchart of a method 400 for processing network packets with the router-bridge systems of the various embodiments. The method 400 includes the following steps:
S402: Receive a plurality of ingress packets by the ingress gateway;
S404: Convert the plurality of ingress packets by the ingress gateway to generate a plurality of L2 packets;
S406: Modify the plurality of L2 packets according to network protocols to generate a plurality of processed packets;
S408: Store the plurality of processed packets to the memory via the bus;
S410: Access the plurality of processed packets from the memory via the bus;
S412: Modify the plurality of processed packets according to the network protocols to generate a plurality of modified packets;
S414: Convert the plurality of modified packets to a plurality of egress packets by the egress gateway; and
S416: Output the plurality of egress packets by the egress gateway.

It should be noted that the network protocols may include layer 2 (L2), layer 3 (L3) and/or layer 4 (L4) protocols, e.g., tunneling, Virtual Private Network (VPN), L2 switching, Network Address Translation (NAT), L3 routing, IPv4 translation, IPv6 translation and TCP processing.

The detailed packet flow has been described in the previous paragraphs, thus, it will not be repeated herein for brevity.

The various embodiments of the present invention combine the functions of a bridge and a router on the ingress frame engines. This eliminates the need for a high-speed interface or trunk between the bridge and the router. Depending on the type of ingress port, offload engines can be dispatched and shared by the corresponding frame engine. These distributed frame engines may have configurable offload engines that can minimize packet latency on each packet flow. The frame engines are in communication with a standard AXI bus for accessing a central selectable memory (e.g., SRAM and DRAM), thereby providing scalable capability when the number of ingress port or the port speed increases. This also eliminates the need of a separate memory block for each bridge, router, or gateway equipment.

The various illustrative components, logic, logical blocks, modules, circuits, engines, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules, engines and circuits described in connection with the aspects disclosed herein may be implemented or performed with a general purpose single-chip processor or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor executable or computer executable instructions encoded on one or more tangible processor readable or computer readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A router-bridge system comprising:
a plurality of frame engines, each frame engine comprising:
an ingress gateway configured to receive a plurality of ingress packets and convert protocols of the plurality of ingress packets to generate a plurality of L2 packets; and
an egress gateway configured to output a plurality of egress packets;
at least one offload engine in communicate with at least two of the plurality of frame engines, and configured to modify the plurality of ingress packet or the plurality of egress packet; and
a bus configured to facilitate communication among the plurality of frame engines;
wherein the at least one offload engine is shared by the at least two of the plurality of frame engines.

2. The router-bridge system of claim 1, wherein an ingress gateway and an egress gateway of one of the plurality of frame engines are 5G Gateway, Gigabit passive optical network (GPON) Gateway or IEEE 802.11 Gateway.

3. The router-bridge system of claim 1, wherein the network protocols comprise layer 2 (L2), layer 3 (L3) and/or layer 4 (L4) protocols.

4. The router-bridge system of claim 1, wherein the bus is an Advanced extensible Interface (AXI) bus.

5. The router-bridge system of claim 1 further comprising a memory configured to store the plurality of processed packets, and download the plurality of processed packets to the each frame engine.

6. The router-bridge system of claim 5, wherein the memory is a static random access memory (SRAM) and/or a dynamic random access memory (DRAM).

7. The router-bridge system of claim 5, wherein the memory is further configured to store in-band packet messages.

8. The router-bridge system of claim 1, wherein the at least one offload engine comprises:
an ingress offload engine in communication with the at least two frame engines, and configured to modify the plurality of L2 packets according to network protocols to generate a plurality of processed packets; and
an egress offload engine in communication with the at least two frame engines, and configured to modify the plurality of processed packets according to the network protocols to generate a plurality of modified packets.

9. A method of processing network packets with a router-bridge system, the router-bridge system comprising a plurality of frame engines, at least one offload engine shared by at least two of the plurality of frame engines, and a bus, the each frame engine comprising an ingress gateway and an egress gateway, the method comprising:
receiving a plurality of ingress packets by the ingress gateway;
converting the plurality of ingress packets by the ingress gateway to generate a plurality of L2 packets;
modifying the plurality of L2 packets according to network protocols to generate a plurality of processed packets;
storing the plurality of processed packets to the memory via the bus;
accessing the plurality of processed packets from the memory via the bus;
modifying the plurality of processed packets according to the network protocols to generate a plurality of modified packets;
converting the plurality of modified packets to a plurality of egress packets by the egress gateway; and
outputting the plurality of egress packets by the egress gateway.

10. The method of claim 9, wherein an ingress gateway and an egress gateway of one of the plurality of frame engines are 5G Gateway, Gigabit passive optical network (GPON) Gateway or IEEE 802.11 Gateway.

11. The method of claim 9, wherein the network protocols comprise layer 2 (L2), layer 3 (L3) and/or layer 4 (L4) protocols.

12. The method of claim 9, wherein the bus is an Advanced extensible Interface (AXI) bus.

13. The method of claim 12, wherein the memory is a static random access memory (SRAM) and/or a dynamic random access memory (DRAM).

14. The method of claim 9, wherein the memory stores in-band packet messages.

15. A router-bridge system comprising:
a plurality of frame engines, each frame engine configured to receive a plurality of L2 packets;
an offload engine in communication with the each frame engine, and configured to modify the plurality of L2 packets according to network protocols to generate a plurality of modified packets; and
a bus configured to facilitate communication among the plurality of frame engines and the memory;
wherein the offload engine is shared by at least two of the plurality of frame engines.

16. The router-bridge system of claim 15, wherein the bus is an Advanced extensible Interface (AXI) bus.

17. The router-bridge system of claim 15, wherein the network protocols comprise layer 2 (L2), layer 3 (L3) and/or layer 4 (L4) protocols.

18. The router-bridge system of claim 15, wherein each frame engine comprises an ingress gateway and an egress gateway.

19. The router-bridge system of claim 15, wherein an ingress gateway and an egress gateway of one of the plurality of frame engines are 5G Gateway, Gigabit passive optical network (GPON) Gateway or IEEE 802.11 Gateway.

20. The router-bridge system of claim 15 further comprising a memory configured to store the plurality of modified packets, and download the plurality of modified packets to the each frame engine.

21. The router-bridge system of claim 20, wherein the memory is a static random access memory (SRAM) and/or a dynamic random access memory (DRAM).

22. The router-bridge system of claim 20, wherein the memory is further configured to store in-band packet messages.
